(19) United States
(12) Patent Application Publication
(10) Pub. No.: US 2011/0209788 A1
(43) Pub. Date: Sep. 1, 2011

(54) VARIABLE WATER DISCHARGE PIPE FOR FAUCET

(75) Inventor: Jong-Ki KIM, Ansan-city (KR)

(73) Assignee: SAMWON COBRA CO., LTD., Ansan-city (KR)

(21) Appl. No.: 12/726,404

(22) Filed: Mar. 18, 2010

(30) Foreign Application Priority Data
Feb. 26, 2010 (KR) 10-2010-0018093

(51) Int. Cl. E03C 1/04; F16L 55/00

(52) U.S. Cl. 137/801; 138/103

(57) ABSTRACT

The present invention relates to a variable water discharge pipe for a faucet with improved durability by making strong a structure of both ends of the variable water discharge pipe. The variable water discharge pipe installed in a faucet connected to waterworks according to an exemplary embodiment of the present invention comprises a soft conduit line formed to allow water to flow inside and to have bushings inserted into both ends of the conduit line, a flexible pipe formed to surround an external circumferential surface of the conduit line, holders formed to fix both ends of the conduit line, and joints provided at both ends of the flexible pipe and formed to support the respective holders. The flexible pipe and the joints are fixed to each other through fusion. The variable water discharge pipe further comprises locking projections formed in an external circumferential surface of each of the bushings in order to firmly fix the bushings within the conduit line. The holder and the joint are integrally assembled to each other in a forcibly fitting manner.

### CROSS-REFERENCE TO RELATED APPLICATION

This application claims priority to and the benefit of Korean Patent Application No. 10-2010-0018093 filed in the Korean Intellectual Property Office on Feb. 26, 2010, the entire contents of which are incorporated herein by reference.

### BACKGROUND OF THE INVENTION

(a) Field of the Invention

The present invention relates to a variable water discharge pipe for a faucet. More particularly, the present invention relates to a variable water discharge pipe for a faucet having a strong structure and improved durability.

(b) Description of the Related Art

In general, a water supply facility is installed in a kitchen so that water can be used in a sink. A faucet for controlling the discharge of tap water is connected to the water supply facility.

The faucet includes a lever for controlling the amount of hot water and cold water discharged and a water discharge pipe for guiding the discharge of tap water.

The faucet installed in the kitchen has a structure in which the tap water is discharged from a certain height so that tasks using the tap water, such as dish-washing, can be easily performed in the sink.

The water discharge pipe constituting the faucet has a variety of shapes. A variable water discharge pipe having a shape in which a user arbitrarily controls the position where tap water is discharged, from among the shapes, is being widely used.

The variable water discharge pipe is configured to freely bend and to maintain a bent state. In such a variable water discharge pipe, a user can arbitrarily change the position where tap water is discharged in all directions and up and down directions. Accordingly, a user can freely move the variable water discharge pipe and conveniently use water.

The variable water discharge pipe includes a soft synthetic resin pipe configured to allow water to flow inside and a flexible pipe configured to surround the external circumferential surface of the synthetic resin pipe.

In such a variable water discharge pipe, the flexible pipe is configured to surround the external circumferential surface of the synthetic resin pipe, plugs are inserted into both ends of the synthetic resin pipe, and a plug holder is provided on the external circumferential surface of the synthetic resin pipe so that the synthetic resin pipe can be protected from the incision surface of the flexible pipe.

Joints are connected to both ends of the variable water discharge pipe. The joint on one side is connected to the lever for controlling the discharge of the tap water, and the joint on the other side is connected to a water saver head from which the tap water is discharged.

The conventional variable water discharge pipe has a structure in which the joints are fixed through pressing. However, after the variable water discharge pipe has been used for a certain period of time, a gap is generated in a portion where the water discharge pipe and the joints are connected to each other. Accordingly, the lever or the water saver head connected to the joint cannot maintain a solid state.

Further, in the conventional variable water discharge pipe, bushings inserted into both ends of a hose are not maintained at the assembled state with the variable water discharge pipe repeatedly used and so separated from the hose because of water pressure, etc.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a variable water discharge pipe for a faucet having an advantage of improved durability by making strong a structure of both ends of the variable water discharge pipe. An exemplary embodiment of the present invention provides a variable water discharge pipe installed in a faucet connected to waterworks, the variable water discharge pipe comprises

a soft conduit line formed to allow water to flow inside and to have bushings inserted into both ends of the conduit line, a flexible pipe formed to surround an external circumferential surface of the conduit line, holders formed to fix both ends of the conduit line, and joints provided at both ends of the flexible pipe and formed to support the respective holders,

wherein the flexible pipe and the joints are fixed to each other through fusion.

The variable water discharge pipe further comprises locking projections formed in an external circumferential surface of each of the bushings in order to firmly fix the bushings within the conduit line. The holder and the joint are integrally assembled to each other in a forcibly fitting manner.

In the variable water discharge pipe for a faucet according to the exemplary embodiment of the present invention, the flexible pipe and the in and out joints assembled with both ends of the flexible pipe are firmly connected to each other through fusion. Accordingly, the durability of the variable water discharge pipe can be improved, and so the life span can be increased.

Further, the holders assembled with both ends of the variable water discharge pipe are integrally assembled with the joints. Accordingly, the holders can be prevented from deviating from the variable water discharge pipe, the production process upon assembly can be simplified, and the productivity of a product can be increased.

### BRIEF DESCRIPTION OF THE DRAWINGS

FIG. 1 is a front view of a variable water discharge pipe for a faucet according to an exemplary embodiment of the present invention;

FIG. 2 is a cross-sectional view illustrating the structure of the variable water discharge pipe for a faucet according to the exemplary embodiment of the present invention;

FIG. 3 is an enlarged cross-sectional view of principal parts of an in joint provided in the variable water discharge pipe for a faucet according to the exemplary embodiment of the present invention; and

FIG. 4 is an enlarged cross-sectional view of principal parts of an out joint provided in the variable water discharge pipe for a faucet according to the exemplary embodiment of the present invention.

<Description of symbols>

| | |
|---|---|
| 2: conduit line | 4: flexible pipe |
| 6: in joint | 8: out joint |
| 10: adapter | 12: screw unit |
| 14: bushing | 16: holder |
| 18: main body | 20: flange unit |
| 22: through hole | 24: locking projection |
| 26: flange unit | 28: locking jaw |
| 30: pressurization unit | 34: fusion |
| 36: packing | 38: snap ring |

### DETAILED DESCRIPTION OF THE EMBODIMENTS

An exemplary embodiment of the present invention will hereinafter be described in detail with reference to the accompanying drawings.

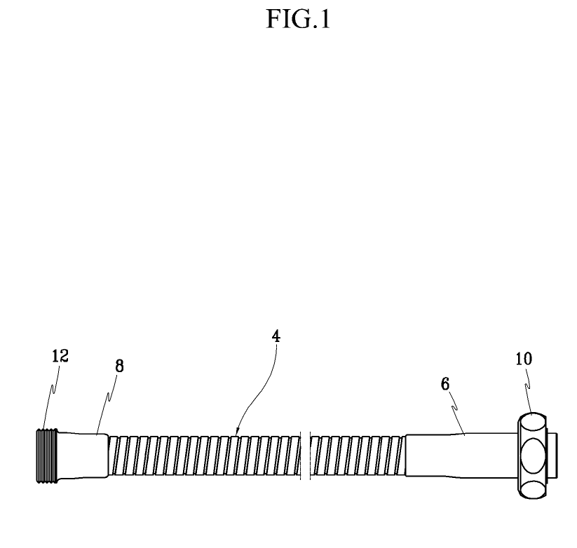

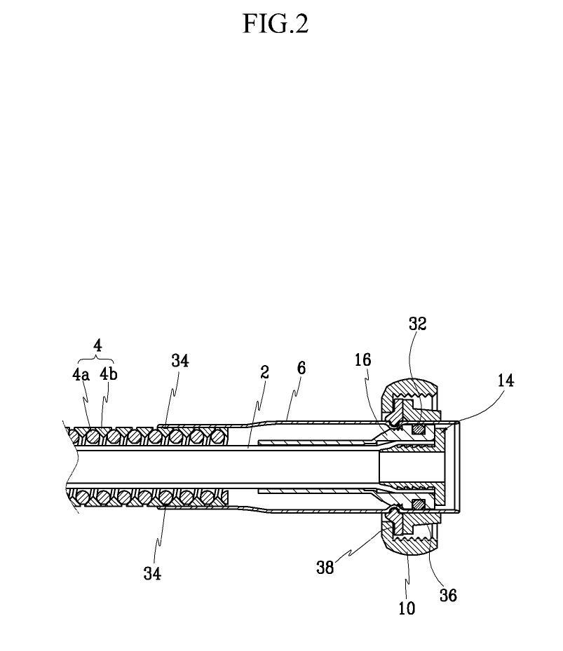

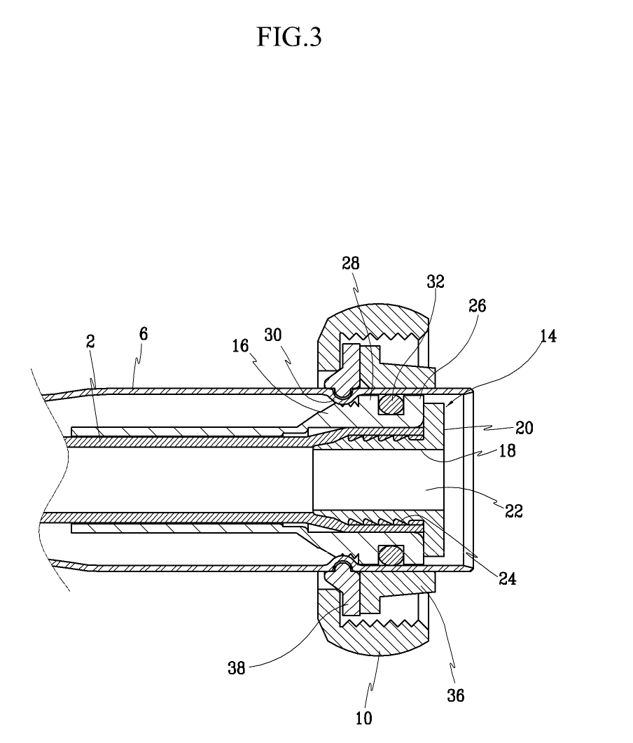

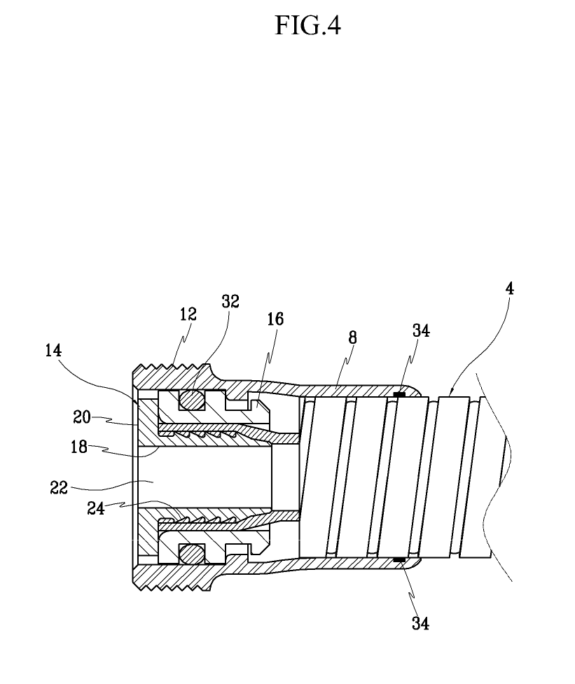

FIG. 1 is a front view of a variable water discharge pipe for a faucet according to the exemplary embodiment of the present invention. FIG. 2 is a cross-sectional view illustrating the structure of the variable water discharge pipe for a faucet according to the exemplary embodiment of the present invention. FIG. 3 is an enlarged cross-sectional view of principal parts of an in joint provided in the variable water discharge pipe for a faucet according to the exemplary embodiment of the present invention. FIG. 4 is an enlarged cross-sectional view of principal parts of an out joint provided in the variable water discharge pipe for a faucet according to the exemplary embodiment of the present invention.

As shown, the variable water discharge pipe for a faucet according to the exemplary embodiment of the present invention includes a soft conduit line 2 configured to allow water to flow inside and a flexible pipe 4 configured to surround the external circumferential surface of the conduit line 2.

The conduit line 2 can be made of material which is harmless to the human body and also freely bent.

The flexible pipe 4 can include a first elastic member 4a configured to have an iron core of a circular cross section wound in a coil form and a second elastic member 4b wound in a coil form between the iron cores of the first elastic member 4a in a surface contact state.

The second elastic member 4b has an approximately triangular cross section. The second elastic member 4b is fabricated in a belt form and wound between the iron cores of the first elastic member 4a in a coil form and in an elastic manner.

Since the first elastic member 4a has the circular cross section, a portion of the second elastic member 4b, bringing in contact with the first elastic member 4a, preferably has a circular groove.

The flexible pipe 4 is configured to freely bend and also maintain a bent state. The structure of the flexible pipe 4 shown in the drawings is only an example, and the exemplary embodiment of the present invention can be applied to the flexible pipe 4 having other forms of structures in the same manner.

Joints 6 and 8 are provided on both ends of the flexible pipe 4. The joints 6 and 8 function to fasten components constituting the variable water discharge pipe and to assemble the variable water discharge pipe with a faucet and a water saver head. The joints 6 and 8 can be made of metal material.

One of the joints 6 and 8 is connected to a faucet (not shown), and the other of the joints 6 and 8 is assembled with a water saver head (not shown). For convenience of description, one of the joints 6 and 8, connected to the faucet and configured to have water flow inside, is called an in joint 6. The other of the joints 6 and 8, configured to have the water saver head assembled therewith and to discharge water, is called an out joint 8.

An adapter 10 is provided in the in joint 6 and configured to connect the in joint 6 to the faucet. A screw unit 12 is provided in the out joint 8 and configured to have the water saver head assembled therewith.

Meanwhile, bushings 14 are inserted into both ends of the conduit line 2. Holders 16 are placed on the respective external circumferential surfaces of the bushings 14 and integrally assembled with the in joint 6 and the out joint 8. The holders 16 function to support the respective bushings 14.

The bushings 14 are supported by the respective holders 16. Accordingly, even though the conduit line 2 is contracted or extended due to the use of cold water or hot water, the bushings 14 constantly maintain the positions of both ends of the conduit line 2.

Each of the bushings 14 includes a main body 18 and a flange unit 20 formed on one side of the main body 18. A through hole 22 for allowing water to flow inside is formed within the main body 18.

The main body 18 of the bushing 14 has an outside diameter slightly greater than an inside diameter of the synthetic resin pipe 2 so that the bushing 14 can be tightly inserted into the conduit line 2.

Furthermore, a number of locking projections 24 are formed in the outer circumferential portion of the main body 18 of the bushing 14 so that the bushing 14 can be fastened to the conduit line 2 more rigidly with it inserted into the conduit line 2. The locking projections 24 have a sawtooth shape so that they can have high friction force. Accordingly, although contractile force or tensile force resulting from a change of water temperature is applied to the conduit line 2, the bushings 14 can remain strongly assembled with the conduit line 2.

Each of the holders 16 supporting the respective bushings 14 has a space portion formed therein so that the conduit line 2 and the main body 18 of the bushing 14 can be inserted into the space portion. The holder 16 has a flange unit 26 formed at its end, and the flange unit 26 of the holder 16 is brought in surface-contact with the flange unit 20 of the bushing 14.

The holder 16 further has a locking jaw 28 spaced apart from the flange unit 26. A pressurization unit 30 is formed in a surface of each of the joints 6 and 8, which brings in contact with the locking jaw 28.

The pressurization units 30 function to pressurize the external circumferential surfaces of the holders 16 assembled inside the respective joints 6 and 8, and so the holders 16 can remain firmly assembled with the joints 6 and 8. Through such an assembly, each of the holders 16 has the same structure as that the holders are assembled with the in joint 6 and the out joint 8, respectively, in a forcibly fitting manner.

The joints 6 and 8 placed on the outer sides of the respective holders 16 have lengths capable of covering both ends of the flexible pipe 4. Each of the joints 6 and 8 is fixed to the flexible pipe 4.

Members constituting the variable water discharge pipe are fixed to and supported by the joints 6 and 8, and the lever and the water saver head are connected to the joints 6 and 8. Particularly, to firmly fix the joints 6 and 8 to the flexible pipe 4 is an important factor to determine the durability of the variable water discharge pipe.

To increase the durability of the variable water discharge pipe, the joints 6 and 8 are fixed to the flexible pipe 4 through fusion 34, and so they have a solid structure.

The fusion 34 can include welding. The welding preferably may be spot welding. The spot welding can be performed at several points along the circumferential surface of the holder 16.

As described above, the variable water discharge pipe according to the exemplary embodiment of the present invention has a strong structure because each of the joints 6 and 8 is integrally fixed to the flexible pipe 4 through the fusion 34. Accordingly, although the variable water discharge pipe is used for a long period of time, each of the joints 6 and 8 remains firmly fixed to the flexible pipe 4, thereby maintaining the durability of the variable water discharge pipe.

Further, an O-ring 32 is inserted into the holder 16 between the flange unit 26 and the locking jaw 28 and configured to prevent the leakage of water.

Unexplained reference numerals 36 and 38 refer to a packing and a snap ring 38 provided within the adapter 10.

The variable water discharge pipe for a faucet according to the exemplary embodiment of the present invention can be used by connecting the in joint 6 to the faucet (not shown) using the adapter 10 and assembling the water saver head (not shown) with the screw unit 12 of the out joint 8.

If a user arbitrarily bends the flexible pipe 4, the conduit line 2 within the flexible pipe 4 is bent in the same shape as the bent flexible pipe 4. Accordingly, the user can freely control the position where water is discharged.

Consequently, a user can conveniently use water because the position where tap water is discharged can be freely controlled.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A variable water discharge pipe installed in a faucet connected to waterworks, the variable water discharge pipe comprising:
a soft conduit line formed to allow water to flow inside and to have bushings inserted into both ends of the conduit line, a flexible pipe formed to surround an external circumferential surface of the conduit line, holders formed to fix both ends of the conduit line, and joints provided at both ends of the flexible pipe and formed to support the respective holders,
wherein the flexible pipe and the joints are fixed to each other through fusion.

2. The variable water discharge pipe of claim 1, wherein
the fusion includes welding.

3. The variable water discharge pipe of claim 1, further comprising
locking projections formed in an external circumferential surface of each of the bushings in order to firmly fix the bushings within the conduit line.

4. The variable water discharge pipe of claim 3, wherein
the locking projections have a saw-tooth shape in order to have high friction force.

5. The variable water discharge pipe of claim 1, further comprising:
a locking jaw formed in an external circumferential surface of each of the holders, and a pressurization unit formed in each of the joints and configured to pressurize the holder adjacent to the locking jaw.
